(19) United States
(12) Patent Application Publication
(10) Pub. No.: US 2024/0068499 A1
(43) Pub. Date: Feb. 29, 2024

(54) BLIND RIVET NUT FOR FIXATION AND SEALING

(71) Applicant: PennEngineering Automotive Fasteners (Kunshan) Co., Ltd., Suzhou (CN)

(72) Inventors: Kun QIN, Suzhou (CN); Hongbing WANG, Suzhou (CN); Yongde LIN, Suzhou (CN); Senyue DUAN, Suzhou (CN)

(21) Appl. No.: 18/454,785

(22) Filed: Aug. 23, 2023

(30) Foreign Application Priority Data
Aug. 25, 2022 (CN) 202222244614.7

(51) Int. Cl. F16B 37/06; F16B 33/00

(52) U.S. Cl. CPC F16B 37/067; F16B 33/004

(57) ABSTRACT

A semiconductor package is disclosed. The semiconductor package comprises: a metal shim, a package substrate attached onto a front side of the metal shim, wherein the package substrate comprises an opening that passes therethough; one or more electronic components mounted on the package substrate; an encapsulant layer partially formed on the package substrate to expose a region of the package substrate and the opening of the package substrate, wherein the encapsulant layer encapsulates the one or more electronic components on the package substrate; a first connector mounted in the exposed region of the package substrate; a second connector mounted in the encapsulant layer and on the package substrate; and a magnet mounted in the opening of the package substrate and extending from the metal shim through the package substrate and the encapsulant layer.

### TECHNICAL FIELD

The present application relates to the technical field of fasteners, in particular to a blind rivet nut for fixation and sealing, a blind rivet mechanism for fixation and sealing, and a device formed by a blind rivet mechanism for fixation and sealing.

### BACKGROUND

In order to meet the requirements of reliable sealing for multi-layer plate connections in battery trays of electrical vehicles, conventionally blind rivet nuts are used for installation. However, due to the thickness of the multi-layer plates and the positional deviation of the installation holes between the plates, using the existing blind rivet nuts for installation can result in problems such as installation distortion, poor bulging, and unreliable sealing. These problems prevent the mass production of the battery pack's structural frame and the optimization for lightweight battery frames.

### SUMMARY

In order to overcome the shortcomings in the existing technology, the present application provides a blind rivet nut for fixation and sealing, a blind rivet mechanism for fixation and sealing, and a device formed by a blind rivet mechanism for fixation and sealing. They are used to solve at least one of the above problems.

According to an aspect of the present application, a blind rivet nut for fixation and sealing is provided. The blind rivet nut comprises: a shank; a flange disposed at one end of the shank and fixedly connected thereto; and a step portion disposed around the shank and at a first side of the flange that is adjacent to the shank, wherein the step portion has an outer diameter greater than that of the shank, and an adhesive part is disposed at the first side of the flange that is adjacent to the step portion.

In some embodiments, the shank has a full hexagonal, half hexagonal, or circular.

In some embodiments, the step portion has a hexagonal or circular cross-portional (cross-section) shape in a radial direction of the blind rivet nut.

In some embodiments, the shank has a first threaded portion at its inside and below the flange, the first threaded portion is formed around an axial direction of the blind rivet nut, and a deformable portion is formed above the first threaded portion.

In some embodiments, the step portion has a transition surface that is formed between an end of the step portion that is away from the flange and the shank.

In some embodiments, the adhesive part has a thickness that decreases gradually from a first position close to the step portion to a second position close to an edge of the flange, and the adhesive part is a flexible sealing adhesive.

In some embodiments, the adhesive part has a thickness at a position close to the step portion equal to a height of the step portion.

In some embodiments, the flange has a sealing gasket disposed at a second side of the flange that is away from the step portion.

In some embodiments, the blind rivet nut further comprises a boss disposed around and fixedly connected to the shank, and the boss is disposed at a second side of the flange that is away from the step portion and abuts against an end surface of the flange.

In some embodiments, the boss further comprises a sealing ring disposed around its outer edge.

According to an aspect of the present application, a blind rivet mechanism for fixation and sealing is provided. The blind rivet mechanism comprises: a first plate, a second plate, and a nut connecting the first plate and the second plate, wherein the first plate has a first opening, the second plate has a second opening, and the nut comprises: a shank; a flange disposed at one end of the shank and fixedly connected thereto; and a step portion disposed around the shank and at a first side of the flange that is adjacent to the shank, wherein the step portion is fixedly connected to the shank; wherein the step portion has an outer diameter greater than that of the shank, and an adhesive part is disposed at the first side of the flange that is adjacent to the step portion; wherein the flange has an outer diameter greater than that of the first opening and the second opening, the step portion is clearance-fitted with the first opening, and the shank is clearance-fitted with the second opening; and wherein the nut has a first threaded portion matable with a second threaded portion on an riveting tool, such that a deformable portion on the first threaded portion can undergo a flow in a radial direction of the nut to form a protrusion part that abuts against a bottom of the second plate, thereby combining/merging the step portion with the first opening and combining/merging the shank with the second opening to connect the first plate with the second plate.

In some embodiments, the step portion has a height smaller than that of the first opening.

According to an aspect of the present application, a device formed by the blind rivet mechanism of any of the above aspects is provided, wherein the bottom of the flange abuts against an end face of the first plate, a sidewall of the first opening is tightly connected to the step portion, a sidewall of the second opening is tightly connected to the shank, a lower end face of the first plate is connected to an upper end face of the second plate, and the deformation portion is connected to a lower end face of the second plate.

The blind rivet mechanism of the present application can bring at least one of the following benefits.

1. A step portion with an outer diameter larger than an outer diameter of a shank is formed on the exterior of the shank. The step portion can mate with a first hole of a first plate while the shank mates with a second hole of a second plate in clearance fit to fix the first plate on the step portion and fix the second plate on the shank. This allows the first plate and the second plate to remain relatively stationary with respect to the shank, thereby enabling the step portion and the shank to limit the two plates in position. In addition, this design can also increase the strength of a flange close to an end of the shank, preventing deformation of the flange after installation. By having the step portion and the shank respectively mate with the first hole of the first plate and the second hole of the second plate in manner of clearance fitting, deformation of the holes of the plates during installation can be avoided, thereby improving product performance and production yield.

2. An adhesive part enables the flange to fixedly connect with the two plates, thereby providing a better connection effect between the blind rivet mechanism and the two plates, and also providing a sealing effect between the flange and the two plates after fixation.

3. The height of the step portion is less than the height of the first hole, thus the step portion would not affect the second plate during the process of fixing the step portion to the first plate. This ensures that the first plate and the second plate can completely adhere with each other after riveting, thereby improving the sealing performance.

In order to make the above and other objectives, features, and advantages of this application more apparent and easier to understand, an embodiment of the present application is described in detail below with the accompanying drawings. It is to be understood that both the foregoing general description and the following detailed description are exemplary and explanatory only, and are not restrictive of the present application. Further, the accompanying drawings, which are incorporated in and constitute a part of this specification, illustrate embodiments of the present application and together with the description, serve to explain principles of the present application.

### BRIEF DESCRIPTION OF THE DRAWINGS

The drawings referenced herein form a part of the specification. Features shown in the drawing illustrate only some embodiments of the present application, and not of all embodiments of the present application, unless the detailed description explicitly indicates otherwise, and readers of the specification should not make implications to the contrary.

FIG. 1 depicts a blind rivet nut for fixation and sealing according to a first embodiment of the present application.

FIG. 2 depicts a blind rivet nut for fixation and sealing according to a second embodiment of the present application.

FIG. 3 depicts a blind rivet nut for fixation and sealing according to a third embodiment of the present application.

FIG. 4 depicts a blind rivet nut for fixation and sealing according to a fourth embodiment of the present application.

FIG. 5 depicts an initial state of an adhesive part of a blind rivet nut for fixation and sealing according to an embodiment of the present application.

FIG. 6 depicts a blind rivet nut for fixation and sealing according to a fifth embodiment of the present application.

FIG. 7 depicts a cross-sectional view of a blind rivet mechanism for fixation and sealing according to an embodiment of the present application.

FIG. 8 depicts a cross-sectional view of a blind rivet mechanism for fixation and sealing according to another embodiment of the present application.

The reference numerals in the above drawings are as follows: 1—shank; 2—flange; 3—adhesive part; 4—step portion; 5—first plate; 51—first hole; 6—second plate; 61—second hole; 7—first threaded portion; 8—deformable portion; 9—protrusion part; 10—boss.

The same reference numbers will be used throughout the drawings to refer to the same or like parts.

### DETAILED DESCRIPTION OF THE PREFERRED EMBODIMENTS

The following detailed description of exemplary embodiments of the present application refers to the accompanying drawings that form a part of the description. The drawings illustrate specific exemplary embodiments in which the present application may be practiced. The detailed description, including the drawings, describes these embodiments in sufficient detail to enable those skilled in the art to practice the present application. Those skilled in the art may further utilize other embodiments of the present application, and make logical, mechanical, and other changes without departing from the spirit or scope of the present application. Readers of the following detailed description should, therefore, not interpret the description in a limiting sense, and only the appended claims define the scope of the embodiment of the present application.

It should be noted that the terms “first”, “second”, etc., are used for description purposes only and should not be understood as indicating or implying relative importance or implicitly indicating the number of technical features indicated. Thus, features defined as “first”, “second”, etc., can explicitly or implicitly include one or more of such features.

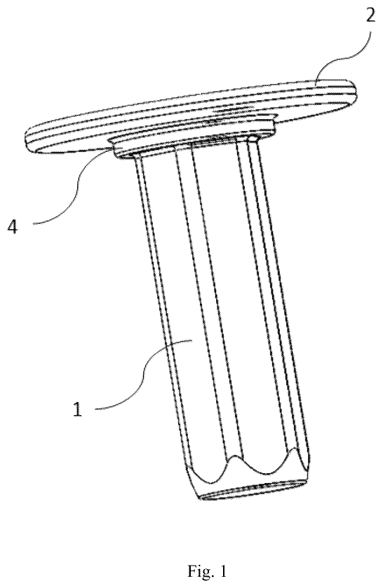

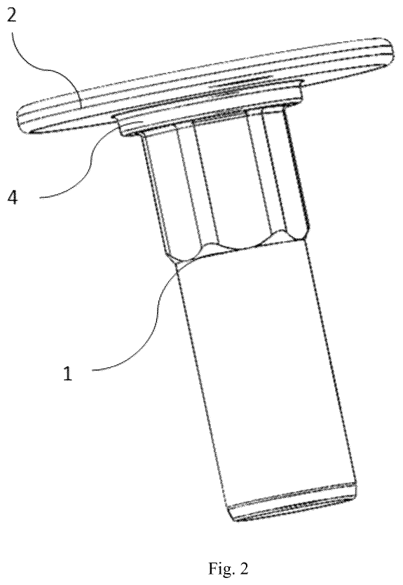

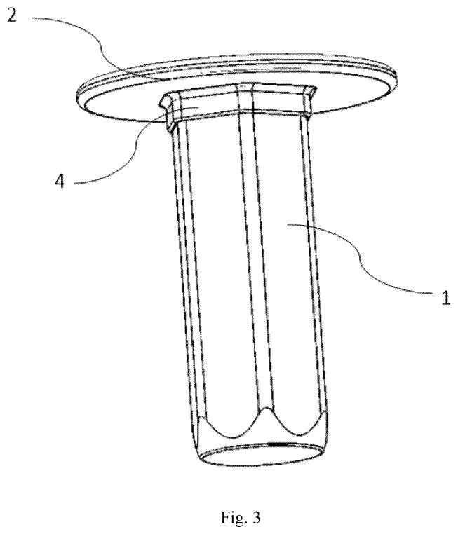

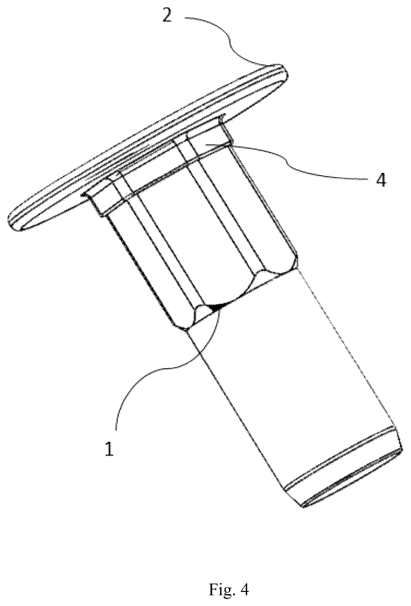

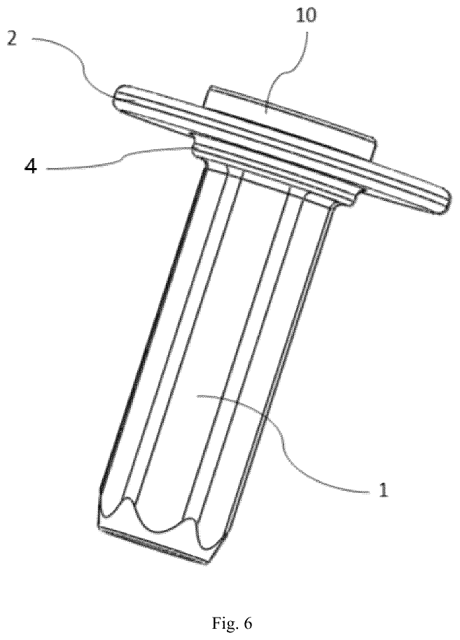

As shown in FIGS. 1 to 8, a blind rivet nut for fixation and sealing is provided according to an embodiment of the present application. The blind rivet nut includes a shank 1; a flange 2 disposed at one end of the shank and fixedly connected thereto; and a step portion 4 disposed around the shank 1 and at a first side of the flange 2 that is adjacent to the shank 1, wherein the step portion 4 is fixedly connected to the shank 1, and wherein the step portion 4 has an outer diameter greater than that of the shank 1, and an adhesive part 3 is disposed at the first side of the flange 2 that is adjacent to the step portion 4.

As shown FIGS. 1 to 6, in the embodiment, the blind rivet nut for fixation and sealing includes the shank 1. The shank 1 has a hexagonal, semi-hexagonal or circular shape in cross section. The hexagonal shape refers to the cross-sectional shape of the shank 1 being entirely hexagonal. The semi-hexagonal shape refers to the cross-sectional shape of the shank 1 at one end adjacent to the flange 2 being hexagonal, and the cross-section of its remaining part being smaller and circularly shaped. The circular shape allows for preliminary fixation of a hole during the subsequent fixation of a plate to the shank 1, by first fixing the circular cross-sectional part of the shank 1 at the other end away from the flange 2 and an intermediate position with the hexagonal cross-section, thereby improving a fixation effect of the plate with the shank. The flange 2 is disposed at one end of the shank 1 and is fixedly connected to the end. The flange 2 has a circular cross-sectional shape in a radial direction. The step portion 4 is disposed on the shank 1. The step portion 4 is located on the side of the flange 2 that is adjacent to the shank 1. The step portion 4 is fixedly connected to the shank 1 and has a hexagonal or circular cross-sectional shape in the radial direction, thereby improving the transition with the shank 1 to save space. The step portion 4 has an outer diameter larger than that of the shank 1. The adhesive part 3 is disposed at the first side of the flange 2 that is adjacent to the step portion 4, allowing the adhesive part 3 to fix the flange 2 to the plate, thereby providing a sealing effect after fixation.

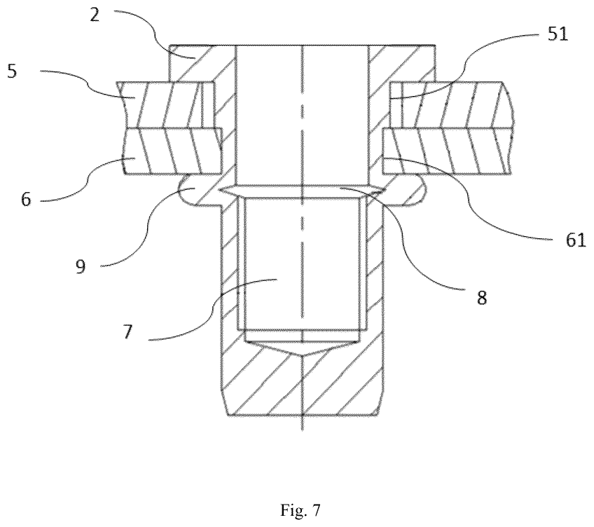

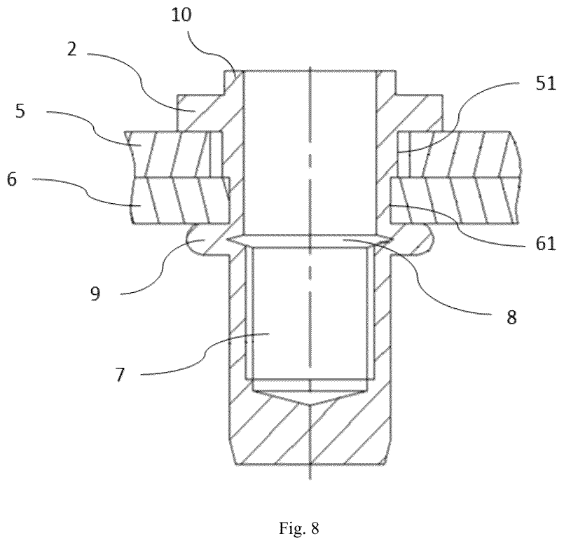

In some embodiments, as shown in FIGS. 7 and 8, in the embodiment, the shank 1 has a first threaded part 7 at its inside, formed axially below the flange 2. A deformable portion 8 is formed above the first threaded portion 7.

In some embodiments, the step portion 4 has a transition surface that is formed between an end of the step portion 4 that is away from the flange 2 and the shank 1. The step transition surface can provide a guiding effect for the hole in the plates during the riveting process, thereby achieving better bonding between the step portion 4 and the plates.

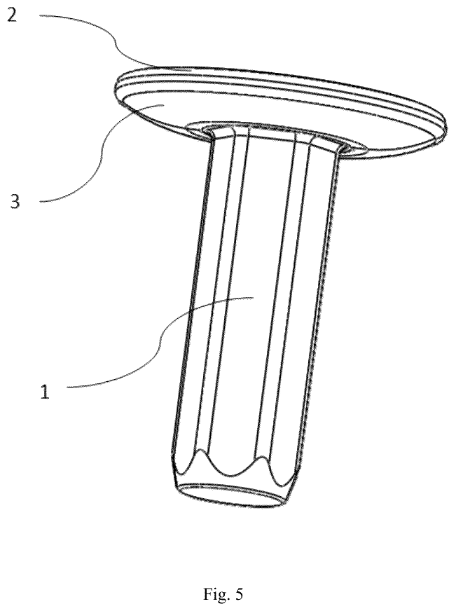

In some embodiments, as shown in FIG. 5, the adhesive part 3 has a thickness that decreases gradually from a first position close to the step portion 4 to a second position close to an edge of the flange 2, and the adhesive part 3 may be a flexible sealing adhesive. Preferably, the adhesive part 3 has a thickness at a position close to the step portion 4 equal to a height of the step portion 4, so that the plates can press against the adhesive part 3 after the entire blind rivet mechanism for fixation and sealing is fixed with the plates. In this way, the adhesive part 3 has a better sealing effect while ensuring the fixing effect of the plates and sealing the plate close to the flange 2. It can be appreciated that the flexible sealing adhesive can have other thicknesses according to the actual needs. The adhesive part 3 can have various colors to mark different blind rivet mechanisms for fixation and sealing.

In some embodiments, a sealing gasket may be disposed at a second side of the flange 2 that is away from the step portion 4, so that the entire blind rivet mechanism for fixation and sealing can maintain a seal with the plates after installation. In a preferred embodiment, the blind rivet nut further includes a boss 10 disposed around and fixedly connected to the shank 1, and the boss 10 is disposed at a second side of the flange 2 that is away from the step portion 4 and abuts against an end surface of the flange 2. The boss 10 further includes a sealing ring disposed around its outer edge. By setting the boss 10 at the flange 2, which abuts against the flange 2, force applied to the riveting nut may concentrate on the shank 1 during installation, thereby increasing the clamping force after installation.

As shown in FIGS. 7 and 8, in an embodiment of the present application, there is also disclosed a blind rivet mechanism for fixation and sealing. The mechanism includes a first plate 5, a second plate 6, and a nut connecting the first plate 5 with the second plate 6. The first plate 5 has a first opening 51, the second plate 6 has a second opening 61, and the first opening 51 might have a different size from the second opening 61. The nut includes a shank 1, which has a hexagonal, semi-hexagonal or circular shape. A flange 2 is disposed at one end of the shank 1, which is fixedly connected to the shank 1 and has a circular cross-section shape in a radial direction. A step portion 4 is disposed around the shank 1 and at a first side of the flange 2 that is adjacent to the shank 1. The flange 2 has an adhesive part 3 at a side that is close to the step portion 4, so that the adhesive part 3 can fix the flange 2 to the first plate 5 and provide a sealing function after fixation. The adhesive part 3 has a thickness at a position close to the step portion 4 equal to a height of the step portion 4, and has a thickness that decreases gradually from a first position close to the step portion 4 to a second position close to an edge of the flange 2. The adhesive part 3 may be a flexible sealing adhesive. In this way, after the first plate 5 is fixed to the nut, the first plate 5 can press against the adhesive part 3, ensuring the fixation effect of the first plate 5 and providing a good sealing effect for the adhesive part 3. As such, the first plate 5 close to the flange 2 is sealed with the flange 2. The adhesive part 3 can have various colors to mark different blind rivet mechanisms for fixation and sealing. The step portion 4 is fixedly connected to the shank 1 and has a hexagonal or circular cross-section shape in the radial direction. The step portion 4 has an outer diameter greater than that of the shank 1, which is also greater than a diameter of a first opening 51 and a diameter of a second opening 61. The step portion 4 is clearance-fitted with the first opening 51 and the shank 1 is clearance-fitted with the second opening 61, thus the step portion 4 can fix the first plate 5 and the shank 1 can fix the second plate 6.

The nut has a first threaded portion 7 which may be compatible with a second threaded portion on a riveting tool, such that a deformable portion 8 above the first threaded portion 7 can undergo a flow in a radial direction of the nut to form a protrusion part 9 that abuts against a bottom of the second plate 6. In this way, the step portion 4 can be bonded with the first opening 51, and the shank 1 can be bonded with the second opening 61, so as to connect the first plate 5 with the second plate 6.

The step portion 4 has a height smaller than that of the first opening 51. After the deformable portion 8 undergoes the radial deformation to form the protrusion part 9, the second plate 6 is connected to the first plate 5 under the pressure of the protrusion part 9, hence the step portion 4 is tightly connected to the first opening 51 and the second opening 61. In this process, the step portion 4 has a height less than the that of the first opening 51 and does not affect the second plate 6 during the fixation process of the first plate 5. It is ensured that the first plate 5 and the second plate 6 achieve a stable connection, thereby increasing the sealing effect.

The present application also discloses in some embodiments a device formed by a blind rivet mechanism for fixation and sealing. Through the above mentioned blind rivet mechanism such as those shown in FIGS. 1 to 8, the bottom of the flange 2 abuts against an end face of the first plate 5, and the first plate 5 and the flange 2 are sealed by the adhesive part 3. A sidewall of the first opening 51 is tightly connected to the step portion 4, and a sidewall of the second opening 61 is tightly connected to the shank 1. A lower end face of the first plate 5 is connected to an upper end face of the second plate 6, and the deformable portion 8 is connected to a lower end face of the second plate 6. The adhesive part 3 can fix the flange 2 to the first plate 5 and provide a sealing function after being fixed.

The present application provides in some embodiments a step portion 4 that has an outer diameter larger than that of the shank 1, which is disposed on the outside of the shank 1. First, the first plate 5 is fixed to the step portion 4 and the second plate 6 is fixed to the shank, through the clearance-fit between the step portion 4 and the first opening 51 and the clearance-fit between the shank 1 and the second opening 61. In this way, it is allowed that the first plate 5 and the second plate 6 remain relatively stationary in relative to the shank 1, thus enabling the step portion 4 and the shank 1 to provide a fixed limiting function for the plate 5 and plate 6. In addition, the strength of the flange 2 at the position close to the end of the shank 1 is improved, which can prevent deformation after installation. Furthermore, the clearance-fit between the step portion 4 and the first opening 51 and clearance-fit between the shank 1 and the second opening 61 can eliminate the deformation of the inner openings of the plate 5 and plate 6 during the installation process, and thus improving the performance and production yield. The adhesive part 3 can fix the flange 2 to the plates to be connected, providing a better connection effect between the blind rivet mechanism for fixation and sealing and the plates, and providing a sealing effect between the flange 2 and the plate 5 or 6.

Various embodiments have been described herein with reference to the accompanying drawings. It will, however, be evident that various modifications and changes may be made thereto, and additional embodiments may be implemented, without departing from the broader scope of the present application as set forth in the claims that follow. Further, other embodiments will be apparent to those skilled in the art from consideration of the specification and practice of one or more embodiments of the present application disclosed herein. It is intended, therefore, that the present application and the examples herein be considered as exemplary only, with a true scope and spirit of the present application being indicated by the following listing of exemplary claims.

What is claimed is:

1. A blind rivet nut for fixation and sealing, comprising:
a shank;
a flange disposed at one end of the shank and fixedly connected thereto; and
a step portion disposed around the shank and at a first side of the flange that is adjacent to the shank, wherein the step portion is fixedly connected to the shank,
wherein the step portion has an outer diameter greater than that of the shank, and an adhesive part is disposed at the first side of the flange that is adjacent to the step portion.

2. The blind rivet nut of claim 1, wherein the shank has a hexagonal, semi-hexagonal or circular shape.

3. The blind rivet nut of claim 1, wherein the step portion has a hexagonal or circular cross-portional (cross-section) shape in a radial direction of the blind rivet nut.

4. The blind rivet nut of claim 1, wherein the shank has a first threaded portion at its inside and below the flange, the first threaded portion is formed around an axial direction of the blind rivet nut, and a deformable portion is formed above the first threaded portion.

5. The blind rivet nut of claim 1, wherein the step portion has a transition surface that is formed between an end of the step portion that is away from the flange and the shank.

6. The blind rivet nut of claim 1, wherein the adhesive part has a thickness that decreases gradually from a first position close to the step portion to a second position close to an edge of the flange, and the adhesive part is a flexible sealing adhesive.

7. The blind rivet nut of claim 1, wherein the adhesive part has a thickness at a position close to the step portion equal to a height of the step portion.

8. The blind rivet nut of claim 1, wherein the flange has a sealing gasket disposed at a second side of the flange that is away from the step portion.

9. The blind rivet nut of claim 1, wherein the blind rivet nut further comprises a boss disposed around and fixedly connected to the shank, and wherein the boss is disposed at a second side of the flange that is away from the step portion, and abuts against an end surface of the flange.

10. The blind rivet nut of claim 9, wherein the boss further comprises a sealing ring disposed around its outer edge.

11. A blind rivet mechanism for fixation and sealing, comprising a first plate, a second plate, and a nut connecting the first plate with the second plate, wherein the first plate has a first opening, the second plate has a second opening, and the nut comprises:
a shank;
a flange disposed at one end of the shank and fixedly connected thereto; and
a step portion disposed around the shank and at a first side of the flange that is adjacent to the shank, wherein the step portion is fixedly connected to the shank;
wherein the step portion has an outer diameter greater than that of the shank, and an adhesive part is disposed at the first side of the flange that is adjacent to the step portion;
wherein the flange has an outer diameter greater than that of the first opening and the second opening, the step portion is clearance-fitted with the first opening, and the shank is clearance-fitted with the second opening; and
wherein the nut has a first threaded portion matable with a second threaded portion on an riveting tool, such that a deformable portion above the first threaded portion can undergo a flow in a radial direction of the nut to form a protrusion part that abuts against a bottom of the second plate, thereby combining/merging the step portion with the first opening and combining/merging the shank with the second opening to connect the first plate with the second plate.

12. The blind rivet mechanism of claim 11, wherein the step portion has a height smaller than that of the first opening.

13. A device formed by the blind rivet mechanism of claim 11, wherein the bottom of the flange abuts against an end face of the first plate, a sidewall of the first opening is tightly connected to the step portion, a sidewall of the second opening is tightly connected to the shank, a lower end face of the first plate is connected to an upper end face of the second plate, and the deformation portion is connected to a lower end face of the second plate.

14. A device formed by the blind rivet mechanism of claim 12, wherein the bottom of the flange abuts against an end face of the first plate, a sidewall of the first opening is tightly connected to the step portion, a sidewall of the second opening is tightly connected to the shank, a lower end face of the first plate is connected to an upper end face of the second plate, and the deformation portion is connected to a lower end face of the second plate.
